(19) United States
(12) Patent Application Publication
(10) Pub. No.: US 2015/0116267 A1
(43) Pub. Date: Apr. 30, 2015

(54) INPUT DEVICE FOR TOUCH OPERATION AND DISPLAY DEVICE

(71) Applicant: Panasonic Intellectual Property Management Co., Ltd., Osaka (JP)

(72) Inventors: Shuji INOUE, Osaka (JP); Hiroyuki KADO, Osaka (JP); Naoki KOSUGI, Kyoto (JP); Toshiyuki AOYAMA, Osaka (JP); Shigeo KASAHARA, Hyogo (JP); Manabu INOUE, Osaka (JP); Akira TOKAI, Hyogo (JP); Kazushige TAKAGI, Osaka (JP); Takahito NAKAYAMA, Osaka (JP)

(21) Appl. No.: 14/528,256

(22) Filed: Oct. 30, 2014

(30) Foreign Application Priority Data
Oct. 30, 2013 (JP) 2013-224944
Oct. 22, 2014 (JP) 2014-215683

(51) Int. Cl. G06F 3/044

(52) U.S. Cl. CPC G06F 3/044
USPC 345/174

(57) ABSTRACT

An input device for detecting a touch operation performed by a user includes a plurality of driving electrodes, and a plurality of detection electrodes which are disposed intersecting with the driving electrodes. The input device detects a position touched by a user by applying a driving signal to the driving electrode and detecting a detection signals outputted from each of the detection electrodes. The detection signal varies with a change in capacitance at an intersection between the driving electrode and the detection electrode. The input device further includes a plurality of signal correctors, each of which is provided for each driving electrode. The signal corrector is configured to add a correction signal to the driving signal in a rising portion and/or a falling portion of the driving signal and apply the driving signal added with the correction signal to the driving electrode.

### BACKGROUND

1. Technical Field

The present disclosure relates to an input device which inputs touch-operated coordinates, and a display device provided with such an input device.

2. Related Art

A display device, which is provided with an input device having an input function of inputting information by a touch operation on a display screen with user's finger or the like, has been employed in a mobile electronic apparatuses such as a PDA and a mobile phone, a variety of home appliances, and stationary customer's guidance terminals such as an unmanned reception machine. As a touch detection type in such an input device by a touch operation, there are known a resistance film touch panel for detecting a change in resistance at a touched portion, a capacitive touch panel for detecting a change in capacitance, an optical sensor type touch panel for detecting a change in amount of light at a portion shaded by a touch, and some other system.

In an input device that adopts the capacitive touch panel, a plurality of driving electrodes and a plurality of detection electrodes are disposed so as to intersect with each other. The driving electrode and the detection electrode constitute a touch sensor at an intersection therebetween. This touch sensor inputs an electric signal and detects a response by means of a change in capacitance between the driving electrode and the detection electrode, to detect contact of an object with a display surface.

Each electrode can be regarded as a distributed constant circuit made up of a resistor R and a capacitor C, and has a different CR time constant depending on a position. Rising/falling of a driving signal transmitted by the driving electrode is rounded by the CR time constant. Therefore, when the CR time constant is large with respect to a pulse width, amplitude of a detection signal detected by the detection electrode cannot be accurately detected.

In order to improve the signal response, there has been proposed a method for accelerating an apparent response by correcting the signal. For example, Japanese Patent Application Laid-Open No. 2005-010202 discloses a method for correcting slow response of liquid crystal by signal processing. The method of Japanese Patent Application Laid-Open No. 2005-010202 performs signal correction on rising/falling signals of the luminance value in the current field, in accordance with a difference between a luminance value of each pixel in a current field and a luminance value of each pixel in a previous field. This can improve the response of liquid crystal.

### SUMMARY

The present disclosure provides an input device capable of reducing deterioration in detection accuracy during a touch operation.

A first input device in the present disclosure is an input device for detecting a touch operation performed by a user. The input device includes a plurality of driving electrodes and a plurality of detection electrodes which are disposed intersecting with the driving electrodes. The input device detects a position touched by a user by applying a driving signal to the driving electrode and detecting a detection signals outputted from each of the detection electrodes. The detection signal varies with a change in capacitance at an intersection between the driving electrode and the detection electrode. The input device further includes a plurality of signal correctors, each of which is provided for each driving electrode. The signal corrector is configured to add a correction signal to the driving signal in a rising portion and/or a falling portion of the driving signal and apply the driving signal added with the correction signal to the driving electrode.

A second input device in the present disclosure is an input device for detecting a touch operation performed by a user. The second input device includes a plurality of driving electrodes, and a plurality of detection electrodes which are disposed intersecting with the driving electrodes. The second input device detects a position touched by a user by applying a driving signal to the driving electrode and detecting a detection signals outputted from each of the detection electrodes. The detection signal varies with a change in capacitance at an intersection between the driving electrode and the detection electrode. The input device further includes a plurality of integrators each of which is configured to integrate each of outputs from the detecting electrodes, and a plurality of phase compensators each of which is configured to perform phase compensation to accelerate response of rising and/or falling of each of outputs of the integrators.

The input device according to the present disclosure is capable of reducing an influence of a time constant of the driving electrode or the detection electrode, thereby to reduce deterioration in detection accuracy during a touch operation.

### BRIEF DESCRIPTION OF DRAWINGS

FIG. 1 is a block diagram for explaining a whole configuration of a liquid crystal display device provided with a touch sensor function according to a first embodiment;

FIG. 2 is a view showing an example of an array of driving electrodes and detection electrodes which constitute a touch sensor;

FIGS. 3A and 3B are views explaining equivalent circuits of a touch sensor in the state of not performing a touch operation and in the state of performing the touch operation, respectively;

FIG. 4 is a diagram showing changes in detection signal in the case of not performing the touch operation and in the case of performing the touch operation;

FIG. 5 is a view showing an array of scanning signal lines in a liquid crystal panel and arrays of the driving electrodes and the detection electrodes in the touch sensor;

FIGS. 6A to 6F are views showing an example of the relation between input of scanning signals to a line block of the scanning signal lines for updating display of the liquid crystal panel and supply of driving signals to a line block of the driving electrode for detecting touch operation in the touch sensor;

FIG. 7 is a timing chart showing the state of applying the scanning signals and the driving signals in one frame;

FIG. 8 is a timing chart for explaining an example of the relation between a display update period and a touch detection period in one horizontal scanning period;

FIG. 9 is a diagram for explaining a configuration of a conventional touch sensor;

FIG. 10 is a diagram for explaining a detailed configuration of the touch sensor according to the first embodiment;

FIG. 11 is a diagram for explaining a time constant of a driving signal at the input end of the driving electrode in the conventional touch sensor;

FIG. 12 is a diagram for explaining reduction in influence of a time constant of the driving signal at the input end of the driving electrode in the first embodiment;

FIG. 13 is a diagram for explaining correction of the driving signal (pulse);

FIGS. 14A and 14B are diagrams for explaining the relation between a correction amount of the driving signal and a waveform output through a signal correction circuit;

FIGS. 15A and 15B are diagrams for explaining a time constant of a conductor formed by combining leading lines and the driving electrodes;

FIGS. 16A and 16B are diagrams explaining a time constant of the detection electrode;

FIG. 17 is a diagram for explaining reduction in influence of the time constant of the detection electrode;

FIGS. 18A to 18C are diagrams showing a constitutional example of a signal corrector;

FIGS. 19A and 19B are diagrams for explaining a time constant of a reception pulse at the end of the detection electrode due to the influence of the time constant of the driving electrode;

FIG. 20 is a diagram showing a constitutional example of a phase compensator; and

FIG. 21 is a diagram for explaining an operation of the phase compensator.

### DETAILED DESCRIPTION OF PREFERRED EMBODIMENT

Hereinafter, embodiments will be described with reference to the drawings as appropriate. However, a description which is more detailed than necessary may be omitted. For example, a detailed description of an already known matter or a repeated description of a substantially the same configuration may be omitted. This is to avoid the following description becoming unnecessarily redundant, and facilitate understanding of a skilled person in the art.

It should be noted that the present inventors provide the attached drawings and the following description in order for the skilled person in the art to fully understand the present disclosure, and do not intend to make those restrict subject matters recited in the claims.

### First Embodiment

Hereinafter, the first embodiment will be described using the attached drawings.

### 1-1. Configuration

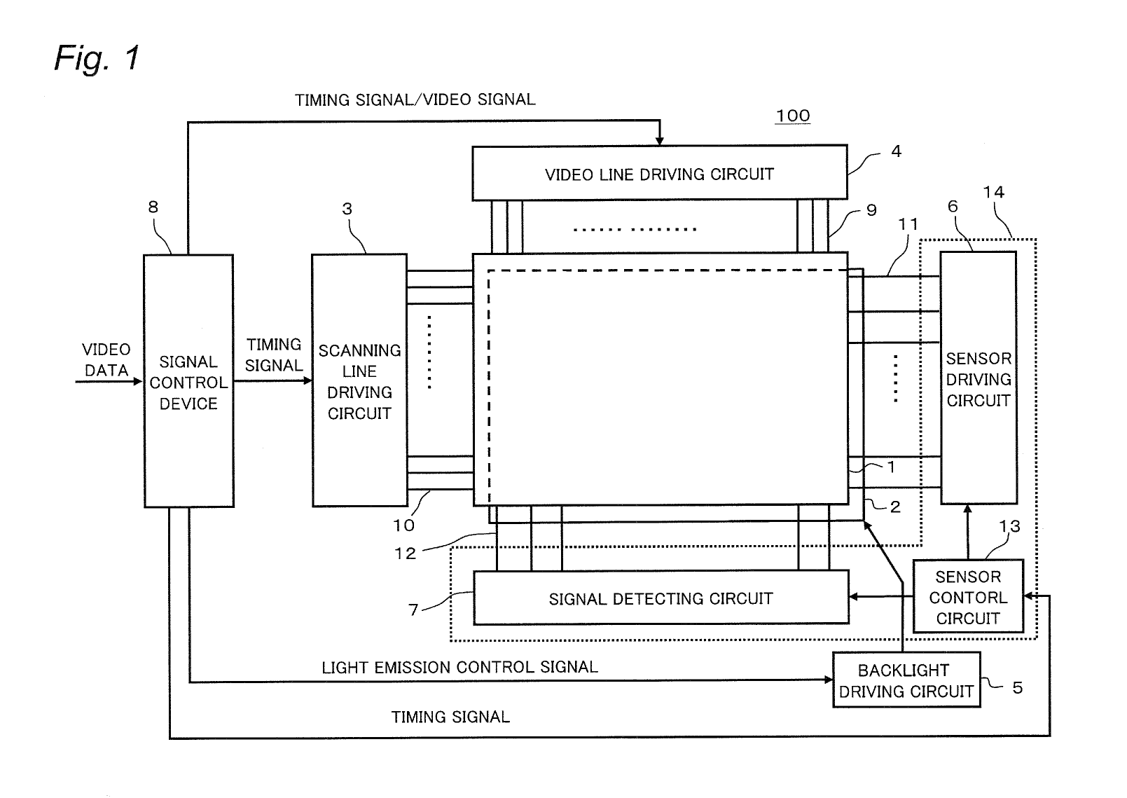

FIG. 1 is a block diagram explaining a whole configuration of a liquid crystal display device provided with a touch sensor function as an input device according to a first embodiment. As shown in FIG. 1, the liquid crystal display device is provided with a liquid crystal panel 1, a backlight unit 2, a scanning line driving circuit 3, a video line driving circuit 4, a backlight driving circuit 5, a signal control device 8, and a touch controller 14.

The liquid crystal panel 1 has a TFT substrate that is made of a transparent substrate such as a glass substrate, and a counter substrate that is disposed forming a predetermined space with this TFT substrate so as to be opposed thereto, and the liquid crystal panel 1 is configured by filling liquid crystal material between the TFT substrate and the counter substrate.

The TFT substrate is located on the rear surface side of the liquid crystal panel 1. On a substrate constituting the TFT substrate, there are formed pixel electrodes disposed two dimensionally, a thin film transistor (TFT) as a switching element which is provided corresponding to the pixel electrode and performs on/off control on application of a voltage to the pixel electrode, a common electrode, and the like.

Further, the counter substrate is located on the front surface side of the liquid crystal panel 1. On a transparent substrate constituting the counter substrate, there are formed a color filter (CF) which is made up of at least three primary colors, red (R), green (G) and blue (B), in a position opposed to the pixel electrode, a black matrix which is made of a shading material for improving contrast and disposed between each RGB subpixels and/or between each pixel made up of the RGB subpixels, and the like. It is to be noted that in the present embodiment, a description will be given assuming that the TFT formed in each subpixel of the TFT substrate is an n-channel TFT.

On the TFT substrate, a plurality of video signal lines 9 and a plurality of scanning signal lines 10 are formed mostly orthogonal to each other. The scanning signal line 10 is provided in a horizontal direction of the TFT, and commonly connected to gate electrodes of the plurality of TFTs. The video signal line 9 is provided in a vertical direction of the TFT, and commonly connected to drain electrodes of a plurality of TFTs. Further, a source electrode of each TFT is connected with the pixel electrode disposed in a pixel region corresponding to the TFT.

An on/off operation of each TFT formed on the TFT substrate is controlled by a predetermined unit in accordance with a scanning signal applied to the scanning signal line 10. Each TFT controlled to be on in a horizontal column sets the pixel electrode to a potential (pixel voltage) in accordance with a video signal applied to the video signal line 9. The liquid crystal panel 1 has a plurality of pixel electrodes and the common electrode opposed to the pixel electrodes, and controls an orientation of liquid crystal with respect to each pixel region by means of an electric field generated between the pixel electrode and the common electrode, to change a transmittance to light incident from the backlight unit 2, thereby forming an image on a display surface.

The backlight unit 2 is disposed on the rear surface side of the liquid crystal panel 1 and emits light from the rear surface of the liquid crystal panel 1. For example, as a backlight unit, there are known one having a structure where a plurality of light-emitting diodes are arrayed to constitute a surface light source, and one having a structure where light of the light-emitting diode is used together with a light-guiding plate and a diffused reflection plate to serve as a surface light source.

The scanning line driving circuit 3 is connected to the plurality of scanning signal lines 10 formed on the TFT substrate. The scanning line driving circuit 3 sequentially selects the scanning signal line 10 in accordance with a timing signal inputted from the signal control device 8, and applies a voltage for turning on the TFT to the selected scanning signal line 10. For example, the scanning line driving circuit 3 is configured including a shift register. The shift register starts an operation upon receipt of a trigger signal from the signal control device 8, sequentially selects the scanning signal line 10 along a vertical scanning direction, and outputs a scanning pulse to the selected scanning signal line 10.

The video line driving circuit 4 is connected to the plurality of video signal lines 9 formed on the TFT substrate. The video line driving circuit 4 applies a voltage corresponding to a video signal indicating a grayscale value of each subpixel to each TFT which is connected to the selected scanning signal line 10 based on selection of the scanning signal line 10 by the scanning line driving circuit 3, Thereby, the video signal is written in the subpixel corresponding to the selected scanning signal line 10.

The backlight driving circuit 5 makes the backlight unit 2 emit light at timing and with luminance corresponding to a light emission control signal inputted from the signal control device 8.

The touch controller 14 is provided with a sensor driving circuit 6, a signal detecting circuit 7, and a sensor control circuit 13. The touch controller 14 controls the touch sensor based on a timing signal inputted from the signal control device 8.

In the present embodiment, a capacitive touch sensor is adopted. The touch sensor is configured of a plurality of driving electrodes 11 and a plurality of detection electrodes 12. In the liquid crystal panel 1, the plurality of driving electrodes 11 and the plurality of detection electrodes 12 are disposed, intersecting with each other.

The touch sensor configured of these driving electrodes 11 and detection electrodes 12 inputs an electric signal and detects a response varied depending on change in capacitance between the driving electrode 11 and the detection electrode 12 to detect contact of an object with the display surface. For electric circuits for detecting the contact, the sensor driving circuit 6 and the signal detecting circuit 7 are provided.

The sensor driving circuit 6 is an alternating current (AC) signal source, and connected to the driving electrode 11. For example, the sensor driving circuit 6 receives input of a sensor signal from the sensor control circuit 13, sequentially selects the driving electrode 11 in accordance with the sensor signal, and supplies a driving signal Txv as a rectangular pulse voltage to the selected driving electrode 11.

It is to be noted that the driving electrodes 11 and the scanning signal lines 10 are formed on the TFT substrate so that the electrodes 11 and the scanning signal lines 10 extend in a horizontal column direction, and a plurality of electrodes 11 and the scanning signal lines 10 are arrayed in a vertical row direction. The sensor driving circuit 6 and the scanning line driving circuit 3 electrically connected to the driving electrodes 11 and the scanning signal lines 10 respectively are disposed on both sides (in a width direction or a horizontal direction) of a display region where the pixels are arrayed. The scanning line driving circuit 3 is disposed on one side of the width direction, and the sensor driving circuit 6 is disposed on the other side thereof.

The signal detecting circuit 7 is a detection circuit for detecting a change in capacitance, and connected to the detection electrode 12. The signal detecting circuit 7 includes detection circuits each of which is provided for each detection electrode 12, and outputs a detection signal Rxv as a change in capacitance detected in the detection electrode 12. It is to be noted that as another constitutional example, one detecting circuit may be provided for each of groups of detection electrodes 12. Then, the detection signal Rxv may be detected and outputted in a time-division manner for each group of detection electrodes 12 in response to a plurality of times of applying pulse voltages to the driving electrode 11.

A contact position of the object on the display surface is found based on a result of determination, by the sensor control circuit 13, about to which driving electrode 11 the driving signal Txv is applied and in which detection electrode 12 a signal generated due to contact is detected, and. An intersection between the driving electrode 11 to which the driving signal Txv has been applied and the detection electrode 12 in which the detection signal Rxv has been obtained is found as the contact position by computing.

The signal control device 8 is provided with an arithmetic processing circuit such as a CPU and memories such as a ROM and a RAM. The signal control device 8 provides predetermined functions by arithmetic processing circuit executing predetermined programs. The signal control device 8 may be composed of a dedicated electric circuit designed to provide predetermined functions. The signal control device 8 performs a variety of image signal processing such as color adjustment based on inputted video data, to generate a pixel signal indicating a grayscale value of each subpixel, and supplies it to the video line driving circuit 4. Further, based on the inputted video data, the signal control device 8 generates a timing signal and supplies it to each of the scanning line driving circuit 3, the video line driving circuit 4, the backlight driving circuit 5 and the controller 14. Moreover, as the light emission control signal to the backlight driving circuit 5, the signal control device 8 supplies a luminance signal for controlling luminance of the light-emitting diode based on the inputted video data.

The sensor control circuit 13 generates the sensor signal in accordance with the timing signal inputted from the signal control device 8, and controls the sensor driving circuit 6 and the signal detecting circuit 7 based on the sensor signal.

Here, the scanning line driving circuit 3, the video line driving circuit 4, the sensor driving circuit 6, the sensor control circuit 13 and the signal detecting circuit 7, which are connected to each signal line and electrode in the liquid crystal panel 1, are each configured by mounting a semiconductor chip of each circuit on a flexible wiring board, a print wiring board or a glass substrate. However, each circuit of the scanning line driving circuit 3, the video line driving circuit 4, the sensor driving circuit 6 and the sensor control circuit 13 may be formed on the TFT substrate simultaneously with the TFT and the like.

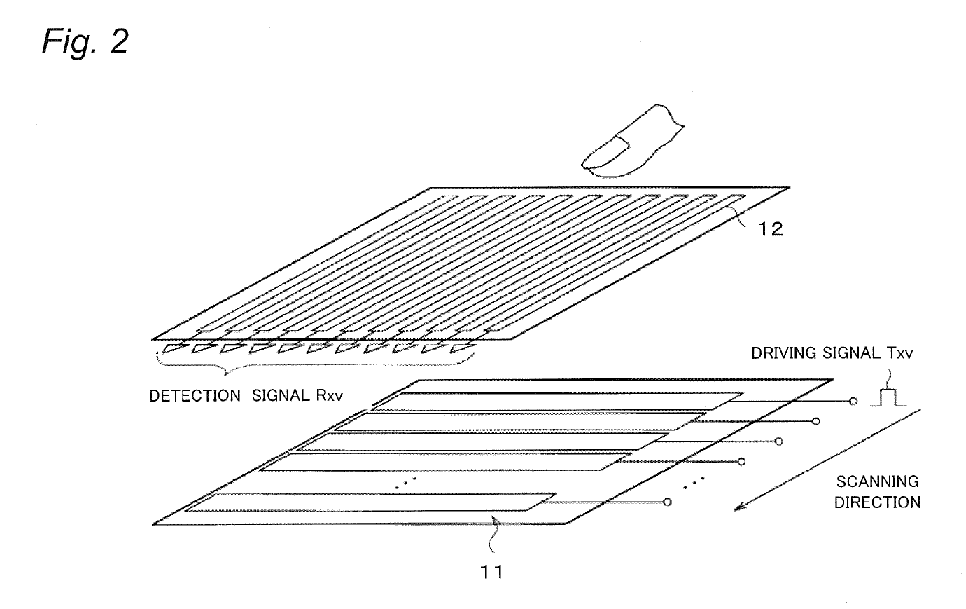

FIG. 2 is a view showing an example of arrays of the driving electrodes and the detection electrodes which constitute the touch sensor. As shown in FIG. 2, the touch sensor as an input device is composed of a plurality of driving electrode 11 as striped electrode patterns extending in the horizontal direction (crosswise direction of FIG. 2), and a plurality of detection electrodes 12 as striped conductors extending in a direction across the extending direction of the conductors of the driving electrodes 11. A capacitive element having a capacitance is formed at each portion where the driving electrode 11 and the detection electrode 12 intersect with each other.

Further, the driving electrodes 11 are arrayed to extend in a direction parallel to the direction in which the scanning signal lines 10 extend. Although described in detail later, the driving electrode 11 is disposed corresponding to each of N (N is a natural number) line blocks when M (M is a natural number) scanning signal lines are taken as one line block. The driving signal Txv is applied to each driving electrode 11 and line block.

At the time of performing a touch detection operation, the driving signal Txv is supplied from the sensor driving circuit 6 to the driving electrode 11 so that scanning is sequentially performed in each line block in a time-division control. Thereby, one line block to be detected is sequentially selected. Further, by receiving the detection signal Rxv from the detection electrode 12, touch detection can be performed in one line block.

### 1-2. Operation

1-2-1. Principle of Touch Detection

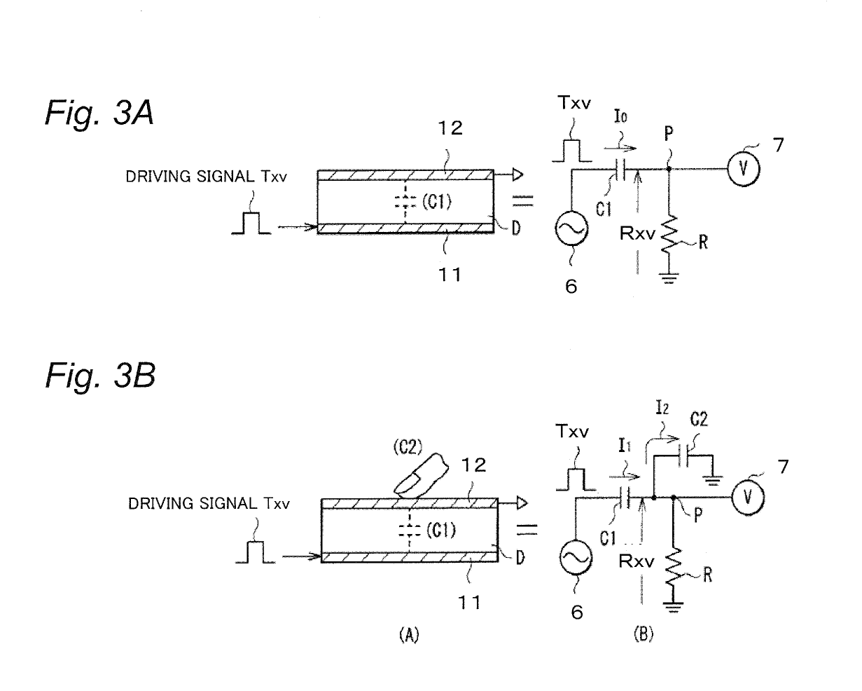

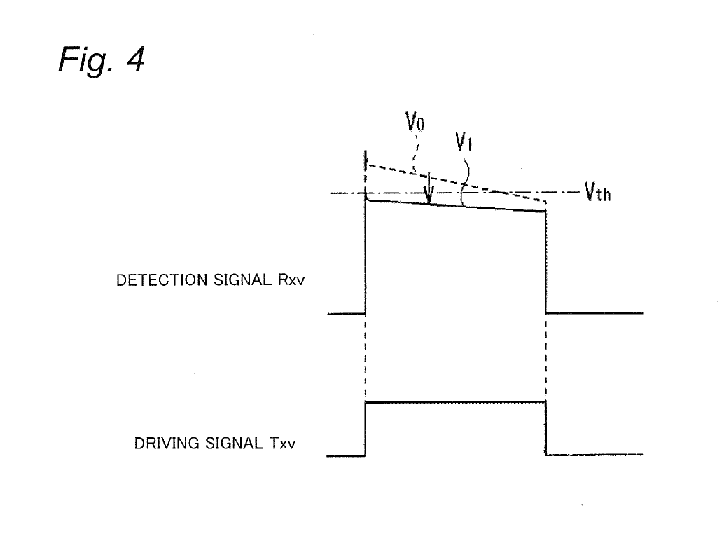

An operation of the liquid crystal display device as thus configured will be described. First, a principle of the touch detection in the input device will be described using FIGS. 3 and 4. The input device of the present embodiment adopts the capacitive touch sensor.

FIGS. 3A and 3B are views explaining schematic configurations and equivalent circuits of the touch sensor in the state of not performing the touch operation (FIG. 3A) and in the state of performing the touch operation (FIG. 3B). FIG. 4 is a diagram explaining changes in detection signal in the case of not performing the touch operation and in the case of performing the touch operation.

In the capacitive touch sensor, a capacitive element is formed at the intersection (cf. FIG. 2) between a pair of driving electrode 11 and the detection electrode 12 which intersect with each other. That is, as shown in FIG. 3A, a capacitive element C1 is made of the driving electrode 11, the detection electrode 12 and a dielectric D. One end of the capacitive element C1 is connected to the sensor driving circuit 6 as an AC signal source, and the other end P is connected to the signal detecting circuit 7 as a voltage detector while being grounded via a resistor R.

When the driving signal Txv (cf. FIG. 4) by a pulse voltage with a predetermined frequency on the order of dozens of kHz to hundreds of kHz is applied from the sensor driving circuit 6 as the AC signal source to the driving electrode 11 (one end of the capacitive element C1), an output waveform (detection signal) Rxv as shown in FIG. 4 appears in the detection electrode 12 (the other end P of the capacitive element C1).

In a state where the finger does not come into touch (nor come close), as shown in FIG. 3A, a current I0 defined in accordance with a capacitance value of the capacitive element C1 flows associated with charging/discharging on the capacitive element C1. A potential waveform at the other end P of the capacitive element C1 at this time becomes like a waveform V0 of the detection signal Rxv shown in FIG. 4, and this is detected by the signal detecting circuit 7 as the voltage detector.

On the other hand, in a state where the finger comes into contact (or come close), as shown in FIG. 3B, the equivalent circuit has a configuration where a capacitive element C2 formed by the finger is added in series to the capacitive element C1. In this state, currents I1 and 12 flow depending on charging/discharging on the capacitive elements C1 and C2, respectively. A potential waveform at the other end P of the capacitive element C1 at this time becomes like a waveform V1 of the detection signal Rxv shown in FIG. 4, and this is detected by the signal detecting circuit 7 as the voltage detector. At this time, the potential at the point P is a potential defined by the currents I1 and I2 flowing through the capacitive elements C1 and C2. Hence amplitude of the waveform V1 becomes a smaller value than amplitude of the waveform V0 in the non-contact state.

The signal detecting circuit 7 compares a potential of the detection signal outputted from each detection electrode 12 with a predetermined threshold voltage Vth. The signal detecting circuit 7 determines the state as the non-contact state when the potential is not smaller than the threshold voltage, and determines the state as the contact state when the potential is smaller than the threshold voltage. In such a manner, the touch detection can be performed. As the method for sensing a signal of a change in capacitance other than the above method, there are a method for sensing a current, and some other method.

### 1-2-2. Method for Driving Touch Sensor

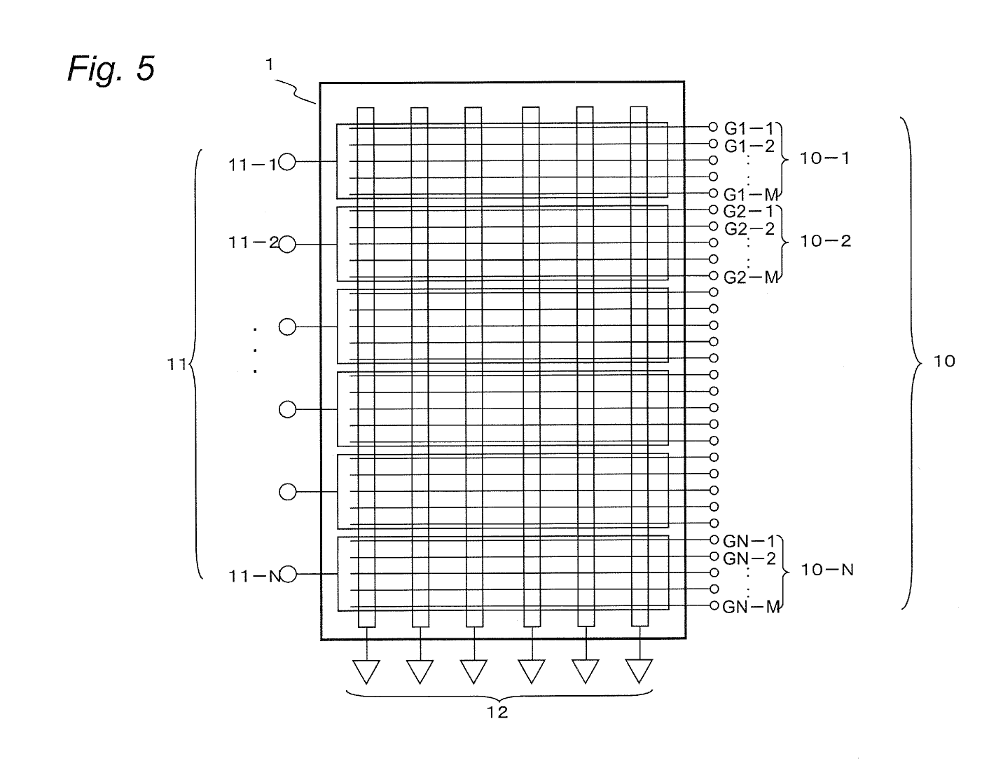

Next, a method for driving a touch sensor in the liquid crystal display device of the present embodiment will be described using FIGS. 5 to 15.

FIG. 5 is a schematic view showing an array structure of the scanning signal lines in the liquid crystal panel and array structures of the driving electrodes and the detection electrodes in the touch sensor.

As shown in FIG. 5, X pieces of scanning signal lines 10 extending in the horizontal direction are grouped by M (M is a natural number) scanning signal lines Gi-1, Gi-2 . . . Gi-M (i is 1 to N). Each group is managed as one line block. That is, the scanning signal lines 10 are arrayed, divided into N (N is a natural number) line blocks 10-1, 10-2 . . . 10-N.

The driving electrodes 11 in the touch sensor are arrayed such that N driving electrodes 11-1, 11-2 . . . 11-N are extended in the horizontal direction in association with the line blocks 10-1, 10-2 . . . 10-N. A plurality of detection electrodes 12 are arrayed so as to intersect with the N driving electrodes 11-1, 11-2 . . . 11-N.

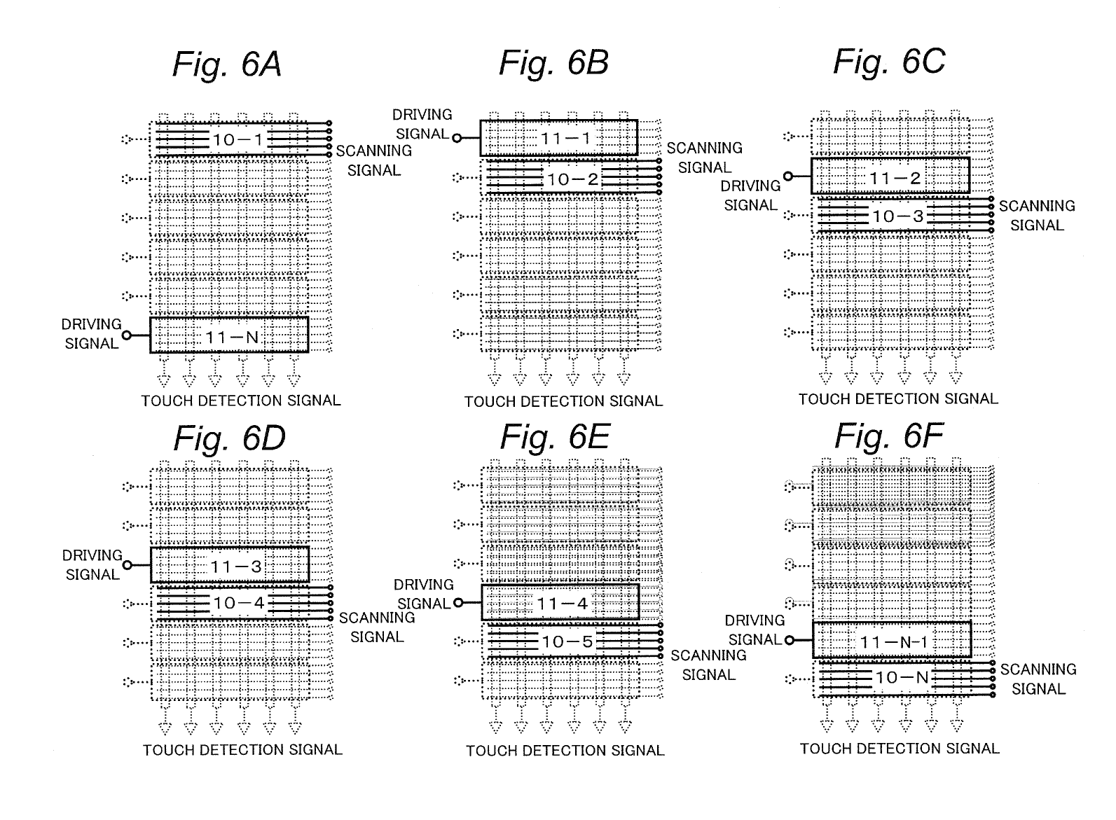

FIG. 6 is an explanatory view showing an example of the relation between input of scanning signals to the line block of the scanning signal lines for updating display of the liquid crystal panel and supply of a driving signal to the line block of the driving electrode for performing the touch detection in the touch sensor. Each of FIGS. 6A to 6F shows a state in one line block scanning period. In the present embodiment, the line block of the scanning signal lines to supply the scanning signals for updating display of the liquid crystal panel is different from the line block of the driving electrode to supply the driving signal for performing the touch detection in the touch sensor.

Specifically, as shown in FIG. 6A, in a horizontal scanning period when the scanning signal is sequentially inputted to each scanning signal line of the first line block 10-1, the driving signal is supplied to the driving electrode 11-N corresponding to the last line block 10-N. In a horizontal scanning period subsequent thereto as shown in FIG. 6B, the scanning signal is sequentially inputted to each scanning signal line of the second line block 10-2, and further, in that horizontal scanning period, the driving signal is supplied to the driving electrode 11-1 corresponding to the first line block 10-1. In a horizontal scanning period subsequent thereto, as shown in FIG. 6C, the scanning signal is sequentially inputted to each scanning signal line of the third line block 10-3. Further, in that horizontal scanning period, the driving signal is supplied to the driving electrode 11-2 corresponding to the second line block 10-2.

Similarly, as shown in FIGS. 6D to 6F, while the line block is sequentially switched to the line blocks 10-4, 10-5 . . . 10-N, the scanning signal is sequentially inputted to each scanning signal line of each line block. Simultaneously, the driving signal is supplied to the driving electrodes 11-3, 11-4, . . . 11-(N−1) corresponding to the line blocks 10-3, 10-4, . . . 10-(N−1) which are one line before the line blocks 10-4, 10-5 . . . 10-N that supply the scanning signals.

That is, in the present embodiment, regarding the drive signal supplied to the driving electrode 11, in one line block scanning period for which a display update (to update a displayed image) is performed, the driving electrode 11-i (i=1 to N), which corresponds to a line block where the scanning signals are not being applied to a plurality of scanning signal lines, is selected and the driving signal is supplied thereto.

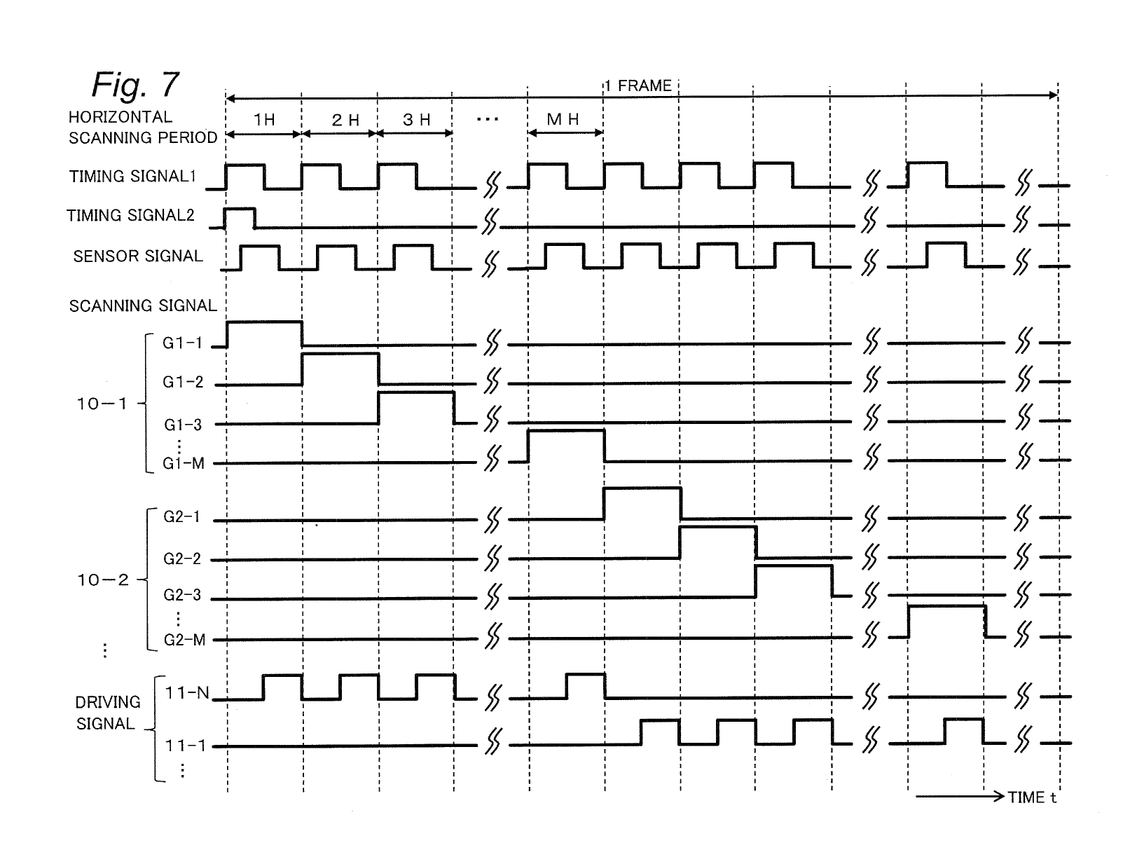

FIG. 7 is a timing chart showing the state of applying the scanning signals and the driving signals in the example shown in FIG. 6. FIG. 7 is a timing chart showing the touch detection operation during a normal mode in the driving method in the present embodiment.

As shown in FIG. 7, in each horizontal scanning period (1H, 2H, 3H . . . MH) in one frame period, the scanning signal is inputted to the scanning signal line 10 by a line block unit (10-1, 10-2 . . . 10-N), to perform display update. Within this period when the scanning signal is being inputted, the driving signal for the touch detection is supplied to the driving electrode 11-N, 11-1, 11-2 or . . . , which corresponds to the line block to which the scanning signal is not being inputted.

The timing signal is generated by the signal control device 8 for the operation of the liquid crystal panel 1. In FIG. 7, a timing signal 1 is a signal that indicates timing for the scanning signal, and a timing signal 2 is a signal that indicates start timing for scanning. FIG. 7 shows an example of starting of scanning from the line block 10-1. Specifically, it shows the operation that when the timing signal 1 is inputted after input of the timing signal 2, the scanning signal is inputted to the scanning signal line G1-1.

Further, the sensor signal is a signal generated for the sensor operation. The sensor signal is generated by the sensor control circuit 13 with a predetermined delay based on the timing signals 1 and 2 inputted from the signal control device 8. The sensor driving circuit 6 supplies the driving signal to the driving electrode 11 based on the sensor signal generated by the sensor control circuit 13. As shown in FIG. 7, in the normal mode, the sensor signal is a signal in synchronization with the scanning signal.

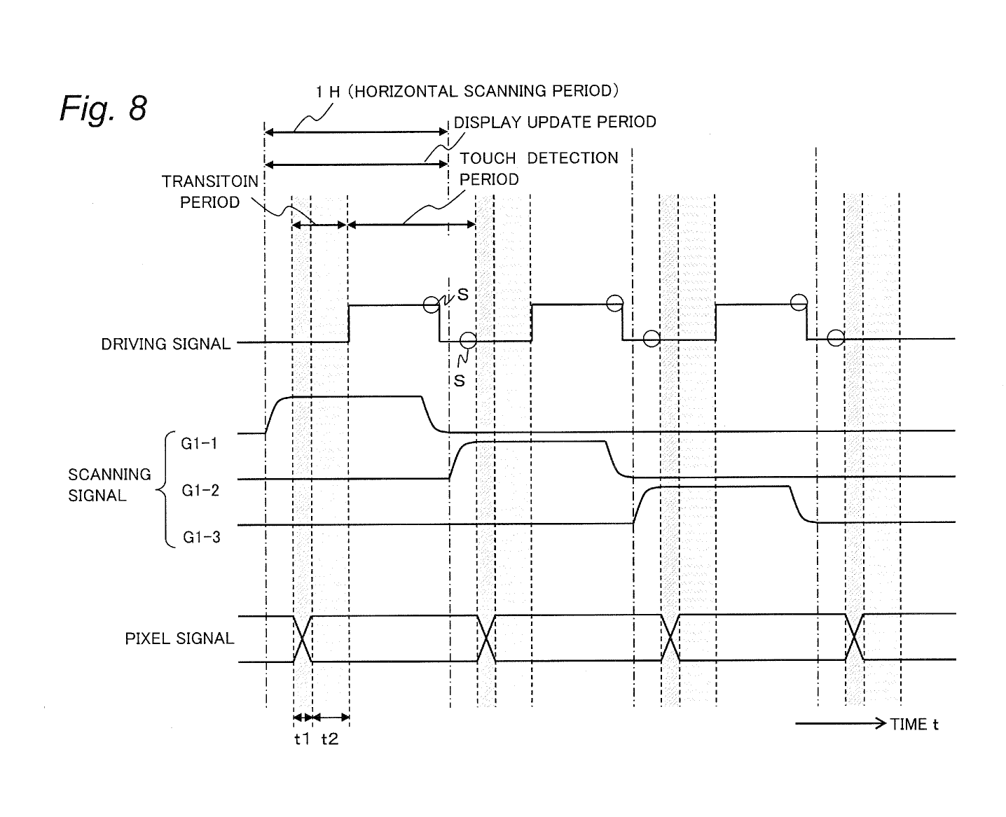

FIG. 8 is a timing chart for explaining an example of the relation between a display update period and a touch detection period in one horizontal scanning period. Further, in the driving method of the present embodiment, a predetermined period does not exist between the scanning signals.

As shown in FIG. 8, in each display update period, the scanning signal is inputted to the scanning signal line 10 (G1-1, G1-2, . . . ) while a pixel signal corresponding to the inputted video signal is inputted to the video signal line 9 connected to the switching element of the pixel electrode in each pixel.

In the present disclosure, the touch detection period is provided at timing in synchronization with the display update period. A period subsequent to a transition period after the start of the display update period is taken as the touch detection period. That is, at a time point when a voltage displacement is converged (becomes stable) followed by rising of the scanning signal to a predetermined potential, a pulse voltage is supplied as the driving signal to the driving electrode 11, and the touch detection period is started from a point of a potential displacement due to rising of the pulse voltage. Further, touch detection timing S exists at two portions, including a point immediately before a pulse voltage falling point and an end point of the touch detection period. Here, the transition period is set to a period including a first-half period t1 for which the pixel signal is displaced, and a period t2 for which a potential of the common electrode is displaced to a potential of a new pixel signal depending on the displacement of the pixel signal. This is to prevent a variation in potential of the common electrode from occurring in the touch detection period due to capacitance coupling of parasitic capacitors in the panel, after the transition period for the pixel signal.

The touch detection operation in the touch detection period is as described using FIGS. 3 and 4.

### 1-2-3. Problem Due to Time Constant of Electrode]

A problem in the conventional capacitive type touch sensor is specifically described below.

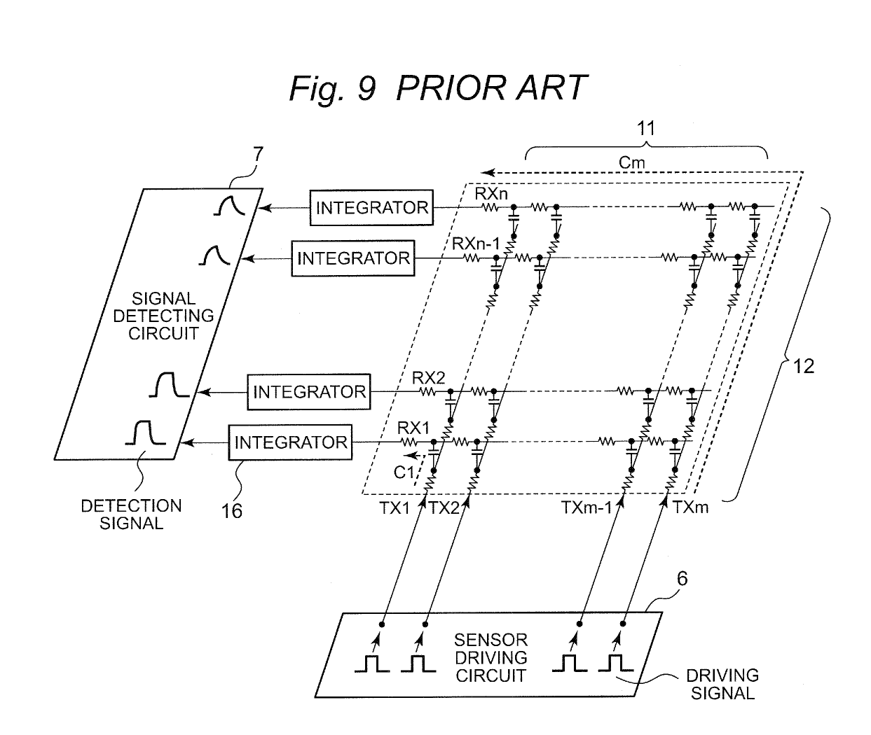

FIG. 9 is a diagram explaining a configuration of the conventional touch sensor. As shown in FIG. 9, a length of a path of the driving electrode 11 and the detection electrode 12 from the sensor driving circuit 6 to the signal detecting circuit 7 varies depending on positions of the driving electrode 11 and the detection electrode 12 which are used for detecting a touch. For example, there is a large difference between a length of a path C1 from the driving electrode TX1 to the detection electrode RX1 and a length of a path Cm from the driving electrode TXm to the detection electrode RXn. When these electrodes have the same width, electric resistances thereof become large in proportion to length thereof. The driving electrode 11 and the detection electrode 12 each have a capacitance with respect to a reference potential of the sensor driving circuit 6. The capacitance of the driving electrode 11 and the detection electrode 12 is a distributed constant depending on the length of the electrode. The resistance and the capacitance of the driving electrode 11 and the detection electrode 12 form a time constant, and the time constant becomes longer as the path of the electrodes used for detection becomes longer. For example, in the case of using the detection electrode RXn, the length of the driving electrode 11 used for detection becomes longer than in the case of using the detection electrode RX1. Hence a time constant of the detection signal of the detection electrode RXn becomes larger than a time constant of the detection signal from the detection electrode RX1.

When the time constant of the driving electrode 11 is large, rising/falling of the driving signal is delayed. Further, the driving signal is outputted in a gap period (predetermined period) between output times of a variety of signals. For this reason, the driving signal needs to be converged to an original signal level within this gap period (predetermined period). However, when the time constant is large and the rising/falling of the driving signal are delayed, the driving signal is not converged within the predetermined time, so that a problem is caused that sensitivity for detecting the touch operation is deteriorated. In the present embodiment, there is provided a configuration for reducing delays in rising/falling of the driving signal due to the time constant.

In the touch sensor for detecting the touch operation by using the driving electrode 11 and the detection electrode 12, the following three time constants can be considered:

(1) A time constant of a leading line of the driving electrode 11;

(2) A time constant of the detection electrode 12; and

(3) A time constant of the driving electrode 11.

Hereinafter, a configuration of the liquid crystal display device of the present embodiment for reducing the influence of each of the time constants is described below.

### 1-2-4. Processing for Reducing Influence of Time Constant

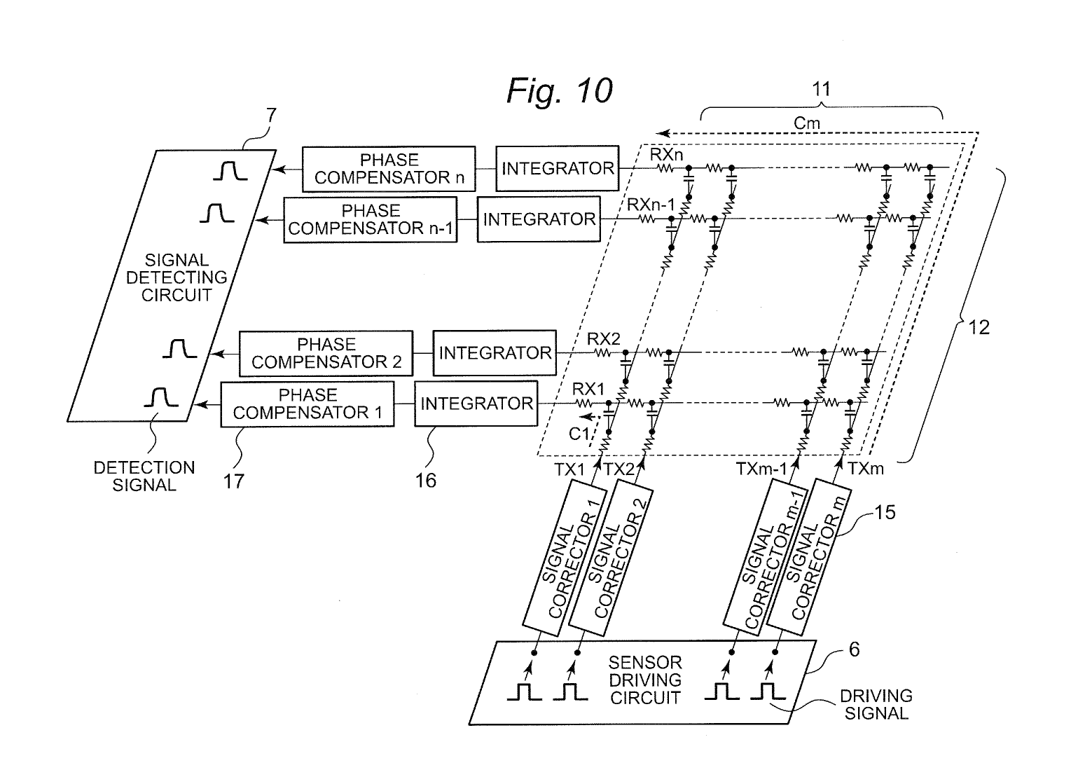

FIG. 10 is a diagram explaining a more detailed configuration of the touch sensor in the liquid crystal display device of the first embodiment for solving the above problem.

As shown in FIG. 10, m (m is a natural number) signal correctors 15 are disposed between m driving electrodes 11 and the sensor driving circuit 6. Further, n (n is a natural number) integrators 16 and n phase compensations 17 are disposed between n detection electrodes 12 and the signal detecting circuit 7. Since the driving electrode 11 is actually a conductor and has an electric resistance in accordance with its length, the driving electrode 11 is expressed in FIG. 10 by an equivalent circuit including a plurality of resistors connected in series.

The signal corrector 15 adds a correction signal to the driving signal outputted from the sensor driving circuit 6 and transmits the driving signal added with the correction signal to the driving electrode 11. The integrator 16 integrates the detection signal detected in the detection electrode 12. Since the driving signal is a detection signal having a shape differentiated by a capacitor formed between the driving electrode 11 and the detection electrode 12, integrating of the detection signal by the integrator 16 leads to regeneration of a detection signal rounded by a time constant in the electrode. The phase compensator 17 performs phase compensation for accelerating rising/falling of the detection signal integrated by the integrator 16, and outputs to the signal detecting circuit 7 a detection signal for which rounding is corrected. Operations of the signal corrector 15 and the phase compensator 17 will be described later.

### 1-2-4-1. Time Constant of Leading Line of Driving Electrode

A configuration for reducing the influence of the time constant of the leading line of the driving electrode 11 is described below.

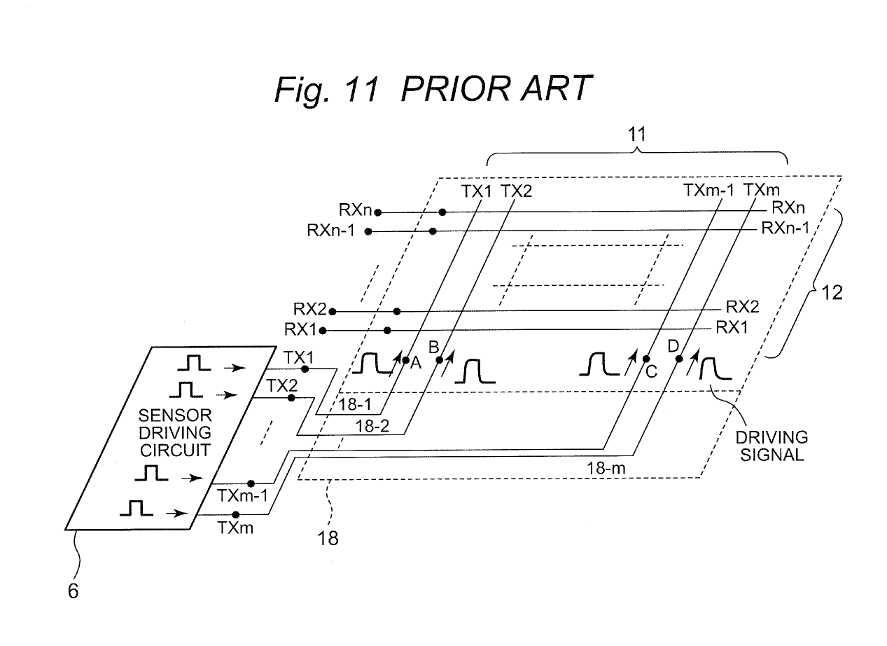

Using FIG. 11, a time constant of a driving signal at the input end of the driving electrode 11 (TX1 to TXm) in the touch sensor is described.

As shown in FIG. 11, when the driving signal from the sensor driving circuit 6 is to be inputted to each of the driving electrodes TX1 to TXm by means of an leading line 18, a time constant at the input end of each of the driving electrodes TX1 to TXm varies since a length of each of leading lines 18-1, 18-2 . . . 18-m varies. In the example of FIG. 11, the leading line 18-1 of the driving electrode TX1 is the shortest and the leading line 18-m of the driving electrode TXm is the longest. When the same driving signal is added to each leading line 18, the time constant of the driving signal at the input end of each driving electrode 11 varies. That is, the time constant of the driving signal increases from the driving electrode TX1 toward TXm. FIG. 11 also illustrates a waveform of the driving signal at each of input ends A, B . . . D. As shown in FIG. 11, the waveform of the driving signal at each of the input ends A, B . . . D changes as influenced by the time constant.

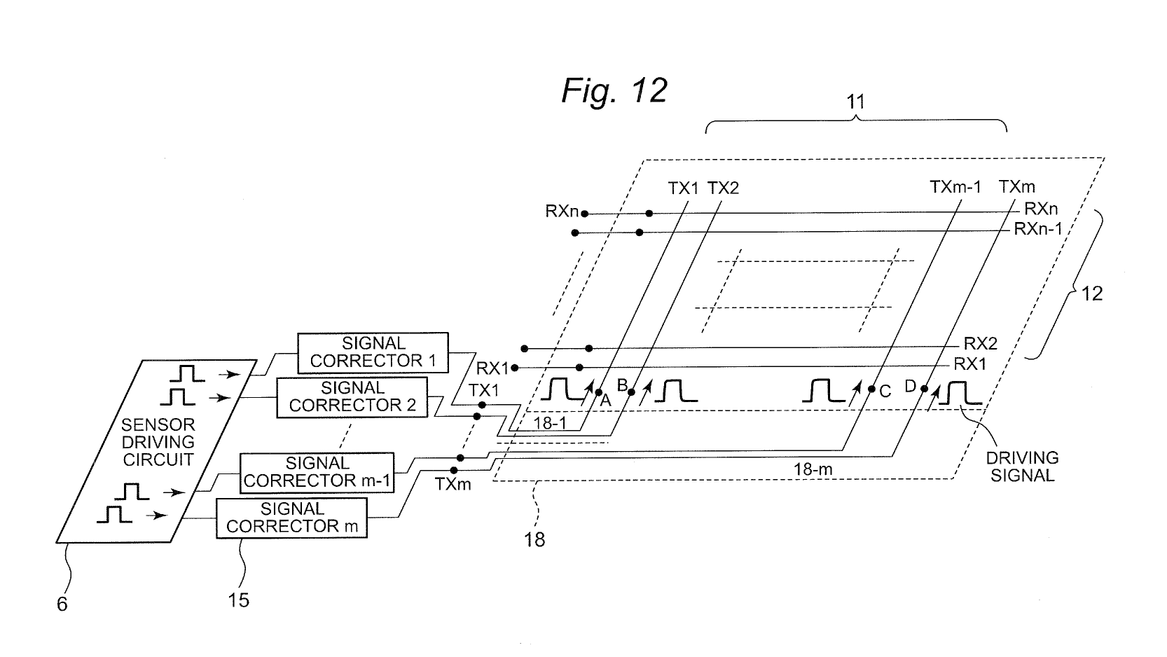

FIG. 12 is a diagram for explaining reduction in influence of the time constant (correction of the time constant) of the driving signal at the input end of the driving electrode 11 (the time constant of the leading line of the driving electrode 11) in the present embodiment.

In the present embodiment, as shown in FIG. 12, the signal corrector 15 is provided between the sensor driving circuit 6 and each of the driving electrodes 11. An amount corrected by the signal corrector 15 is set so as to increase from TX1 toward TXm. FIG. 12 also illustrates respective waveforms of the driving signal at the input end A of the driving electrode TX1, the driving signal at the input end B of the driving electrode TX2, the driving signal at the input end C of the driving electrode TXm-1, and the driving signal at the input end D of the driving electrode TXm. As shown in the drawing, the time constants of the respective driving signals can be made uniform at the input ends A to D of the respective driving electrodes TX1 to TXm.

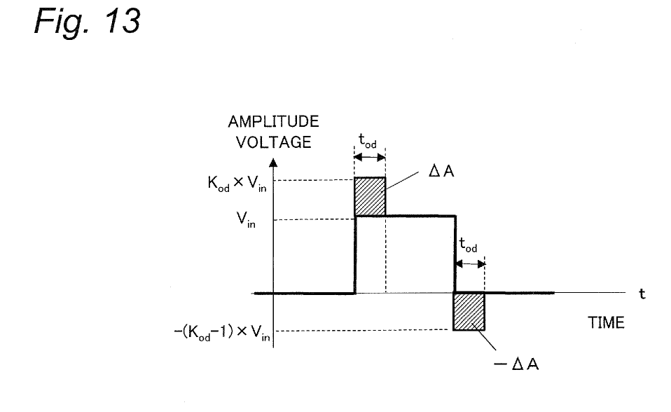

An operation of the signal corrector 15 is described below in detail. As shown in FIG. 13, the signal corrector 15 corrects the driving signal by adding correction voltages ΔA/−ΔA at rising/falling edges of a driving signal pulse. That is, the signal corrector 15 corrects the waveform such that amplitude of the driving signal is increased to a higher value (Kod·Vin) than original amplitude (Vin) for a fixed period (tod) in the rising of the driving signal, and the amplitude of the driving signal is decreased to a lower value (−(Kod−1)·Vin) for a fixed period (tod) in the falling of the driving signal. This leads to reduction in response delay in the rising/falling of the driving signal due to the time constant, to obtain as a result a similar effect to that in the case of correcting the time constant. The correction amount ΔA of the driving signal in the rising/falling of the driving signal is set in accordance with the length of the leading line 18 of each of the driving electrodes TX1 to TXm. A circuit configuration of the signal corrector 15 is described later.

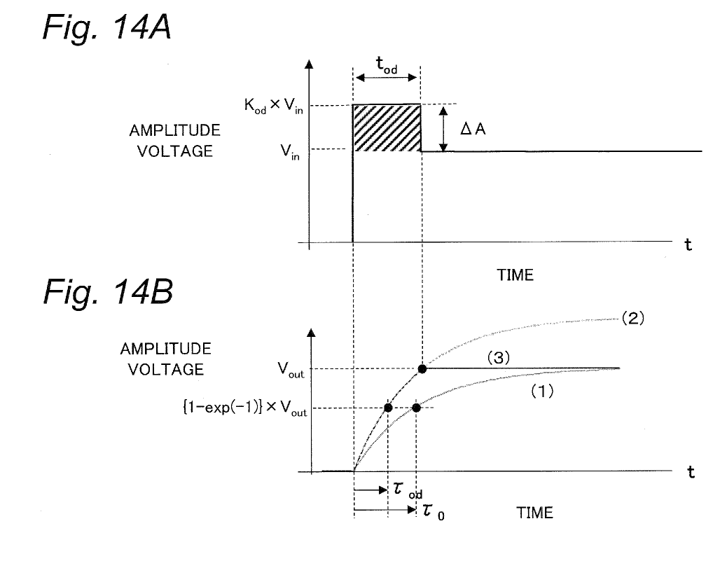

FIG. 14 is a diagram for explaining the relation between a correction amount of the driving signal and a waveform at the time of correction in the first embodiment. FIG. 14A is a diagram showing a waveform of the driving signal after correction by the signal corrector 15. FIG. 14B shows a waveform of the driving signal obtained by passing the driving signal of FIG. 14A through a signal transmission path with a time constant τ0. In FIG. 14A, a vertical axis indicates an amplitude voltage of the driving signal, and a horizontal axis indicates time t. Further, in FIG. 14B, a vertical axis indicates an amplitude voltage of the driving signal, and a horizontal axis indicates time t. In FIG. 14A, a shaded area corresponds to the correction amount. Here, correction is performed by the signal corrector 15 such that the amplitude after the correction becomes Kod times as large as the amplitude (Vin) of the original signal, during the fixed period (tod) in the rising of the driving signal. The signal correction amounts Kod, tod can be expressed by Expressions (1) and (2) by using τod and τ0, where τ0 is a time constant before the signal correction, τod is a time constant after the signal correction, Vin is an amplitude voltage before the correction, and Vout is an amplitude voltage after the correction.

Kod={1−exp(−1)}/{1−exp(−τod/τ0)} (1)

tod=−τ0−ln(1−1/Kod) (2)

A curve (1) of FIG. 14B is a waveform of the driving signal that is not subjected to the signal correction of FIG. 14A. Adding the time constant τ0 to the amplitude voltage Vin of the driving signal for unlimited time causes the amplitude voltage to converge to the voltage Vout. A curve (2) is a waveform in the case of keeping the adding of the amplitude voltage Kod·Vin during the signal correction of FIG. 14A. In the case of the curve (2), when the amplitude voltage of the signal correction decreases from Kod·Vin to Vin as a limit value as shown in FIG. 14A at a point of the amplitude (1) reaching Vout, the curve becomes as indicated by a curve (3). The curve (3) shows that the time constant apparently decreases from τ0 to τod as compared to the curve (1). It means that the time constant has been able to be corrected.

Although the correction of the rising portion of the driving signal has been described in the foregoing example, a similar correction can be performed also in the falling portion of the driving signal. That is, the amplitude voltage may be decreased in the falling portion just by ((Kod−1)·Vin) which corresponds to the increased amount of the amplitude voltage in the rising portion of the driving signal.

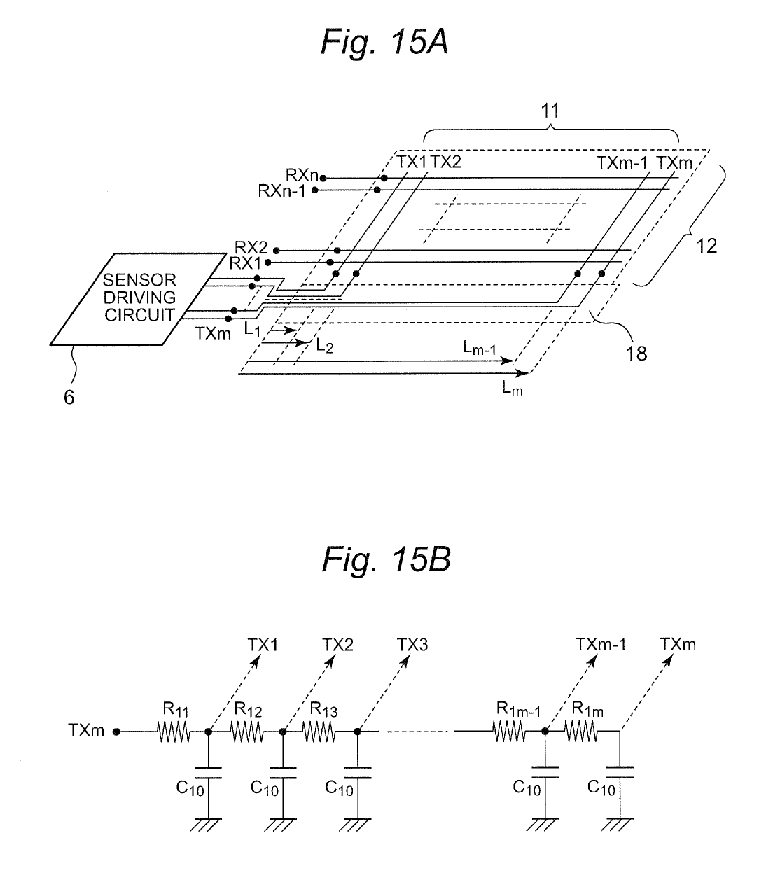

FIG. 15 is a diagram explaining a time constant of a conductor formed by combining the driving electrode 11 and the leading lines 18 in the first embodiment. As shown in FIG. 15A, when lengths of the leading lines 18 of the driving electrodes TX1 to TXm are L1 to Lm and a resistance ratio of a unit length of the leading line 18 is ρ1, a resistance value R1i (i=1, 2 . . . m) of each leading line 18 between the adjacent driving electrodes TX1 to TXm is expressed by Expression (3).

R1i=ρ1·(Li−L(i−1)) (3),

where R11=ρ1·L1=R10 and L1=Li−L(i−1), R1i=R10 (i=1, 2 . . . m).

Further, when an equivalent capacitance at the input end of the driving electrode 11 is C10, an equivalent circuit of the leading line 18 is expressed by a multi-stage circuit of CR as in FIG. 15B. Therefore, a time constant τ1i of the i-th driving electrode TXi (i=1, 2 . . . m) is expressed by Expression (4) by use of Elmore approximation which is generally known.

τ1i=i·(i+1)·C10·R10/2 (4)

Here, the time constant of TX1 is made equal to the time constant of TXm. That is, for TX1, Kod=1 and tod=0. Further, for TXi (i=1, 2, 3 . . . m), by substitution of τod=τ11 and τ0=τ1i in Expressions (1) and (2), it is possible to find the signal correction amounts Kod, tod of each of the driving electrodes TX1 to TXm.

### 1-2-4-2. Time Constant of Detection Electrode

Next, a configuration for reducing the influence of the time constant of the detection electrode 12 is described below.

In FIG. 12, focusing on one of the detection electrodes RX1 to RXn, a length of a path from the output end of each of the detection electrodes RX1 to RXn to the intersection between the detection electrode and the driving electrode varies in accordance with each of the driving electrodes TX1 to TXm intersecting with the detection electrodes. For this reason, the time constant of the detection signal varies in accordance with each of the driving electrodes TX1 to TXm intersecting with the detection electrode 12. Therefore, by performing correction by the signal corrector 15 in consideration of the time constant due to the length of the detection electrode 12 (i.e., the length from the output end of the detection electrode 12 to the intersection between the detection electrode 12 and the driving electrode), it is possible to reduce the influence due to the time constant of the detection electrode 12.

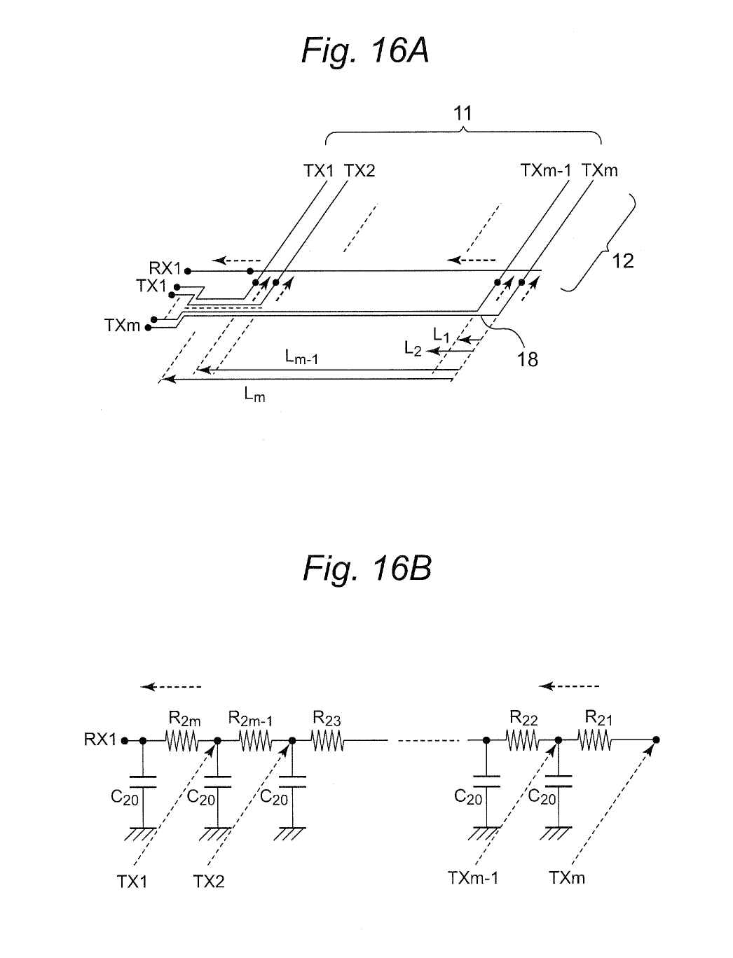

FIG. 16 is a diagram explaining the time constant of the detection electrode 12 in the first embodiment. FIG. 16 shows only the driving electrode 11 and the detection electrode RX1 for convenience of description. The other detection electrodes 12 can be expressed by the same circuit, and hence descriptions thereof are omitted. When the resistance ratio of the unit length of the detection electrode 12 is ρ2, each resistance value R2i (i=1, 2 . . . m) of the detection electrode 12 in a section separated by each of the adjacent driving electrodes TX1 to TXm is expressed by Expression (5).

R2i=ρ2·(Li−L(i−1)) (5),

where R21=ρ2·L1=R20, and L1=Li−L (i−1), R2i=R20 (i=1, 2 . . . m).

Further, when an equivalent capacitance at the intersection between each of the driving electrodes TX1 to TXm and the detection electrode RX1 is C20, an equivalent circuit is expressed by a multi-stage circuit of CR as shown in FIG. 16B. The time constant obtained by combining the time constants of the leading line 18 and the detection electrode 12 is expressed by Expression (6) by means of Elmore approximation.

τ2i=i·(i+1)·(C10·R10+C20·R20)/2 (i=1,2 . . . ,m) (6),

where, the time constant from TX1 to RX1 is made equal to the time constant from TXm to RX1. For TX1, kod=1 and tod=0. Further, for TXi (i=1, 2 . . . m), by substitution of τod=τ21 and τ0=τ2i in Expressions (1) and (2), it is possible to obtain the signal correction amounts kod, tod of each of TX1 to TXm. In Expression (6), the time constant of the leading line 18 may not be considered but only a term (C20·R20) of the time constant of the detection electrode 12 may be considered.

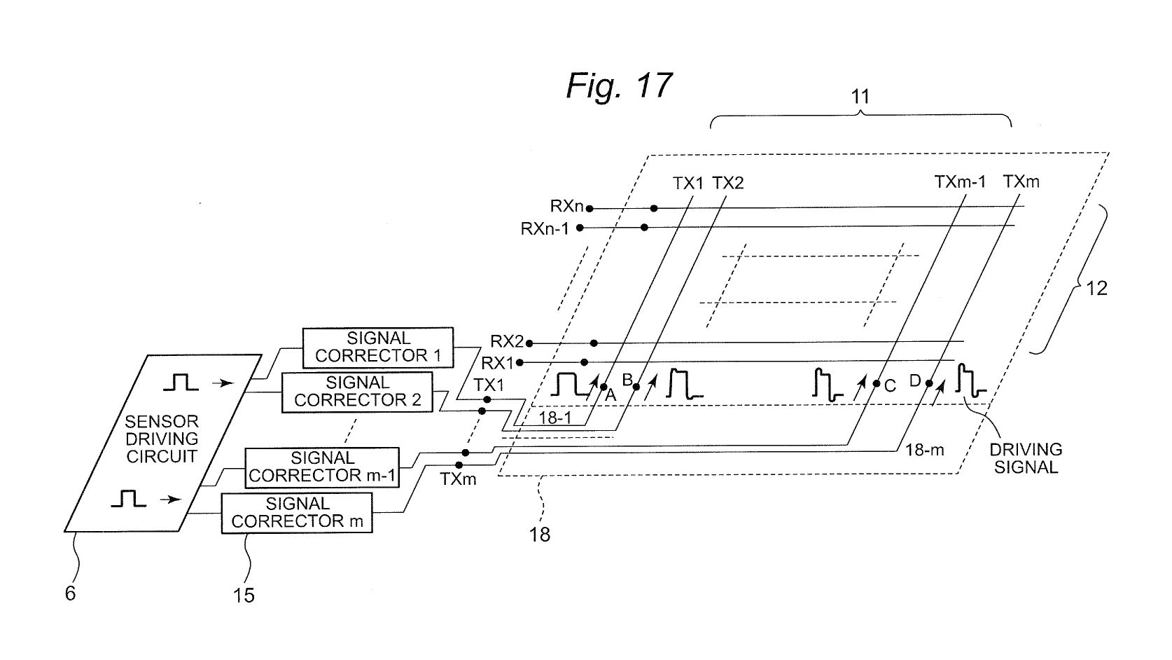

FIG. 17 is a diagram explaining reduction in influence of the time constant (correction of the time constant) of the detection electrode 12 in the first embodiment. FIG. 17 shows the driving signal 1 to the driving signal m after the correction by the signal corrector 15. FIG. 17 also illustrates waveforms of the driving signal at the input end A of the driving electrode TX1, the driving signal at the input end B of the driving electrode TX2, the driving signal at the input end C of the driving electrode TX(m 1), and the driving signal at the input end D of the driving electrode TXm. As shown in FIG. 17, the waveform of each driving signal is a waveform added with an overshoot at a rising edge and added with an undershoot at a falling edge. With such an added overshoot and an added undershoot, a driving signal waveform (pulse) with a uniform time constant can be received at the output end via the detection electrode 12 with respect to a pulse of any one of TX1 to TXm.

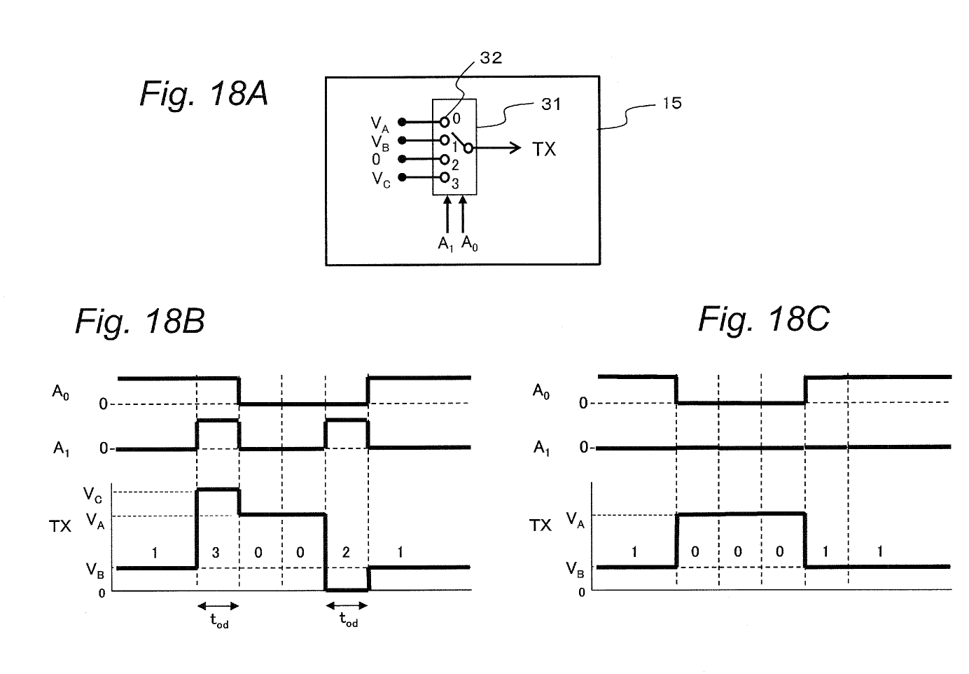

The signal corrector 15 is described below. FIG. 18 is a diagram showing a constitutional example of the signal corrector 15 in the first embodiment.

As shown in FIG. 18A, the signal corrector 15 has four switching terminals 32 and a selector 31. The selector 31 selects either one of the four switching terminals 32 in accordance with 2-bit signals A1 and A0. Either one of selector numbers 0 to 3 is designated by means of a value (A1·2+A0) shown by the 2-bit signals A1 and A0.

FIGS. 18B and 18C are diagrams each showing a state where the selector is switched by means of the pulse signals A1 and A0 to generate the driving signal. 0 to 3 in the drawing each shows the state of the selected selector. In the case of this example, the signals A1 and A0 are outputted from the sensor driving circuit 6. FIG. 18B shows an example of the driving signal subjected to signal correction, and FIG. 18C shows an example of a conventional driving signal not subjected to signal correction.

As shown in FIG. 18B, the selector 31 switches and outputs four kinds of voltages shown hereinafter by means of the values A1 and A0.

(1) In case of (A1, A0)=(0, 1)
A voltage VB is selected, and an amplitude voltage of the driving signal TX is VB.

(2) In case of (A1, A0)=(1, 1)
A voltage VC is selected, and the amplitude voltage of the driving signal TX is VC.

(3) In case of (A1, A0)=(0, 0)
A voltage VA is selected, and the amplitude voltage of the driving signal TX is VA.

(4) In case of (A1, A0)=(1, 0)
A voltage 0 is selected, and the amplitude voltage of the driving signal TX is 0.
   By the above operation, the signal added with the correction signal from the signal corrector 15 is outputted.

### 1-2-4-3. Time Constant of Driving Electrode

Next, a configuration for reducing the influence of the time constant of the driving electrode 11 is described.

In FIG. 11, focusing on one driving electrode, a length of a path from the input end of the driving electrode TX1 to TXm to the intersection between the detection electrode and the driving electrode varies in accordance with a position of the detection electrode RX1 to RXn intersecting with the driving electrode. The time constant of the driving electrode varies depending on this difference in length of the path. Therefore, by correcting the time constant due to the length of the driving electrode (the length from the input end of the driving electrode to the intersection between the detection electrode and the driving electrode) with the phase compensator 17, it is possible to reduce the influence due to the time constant of the driving electrode 11.

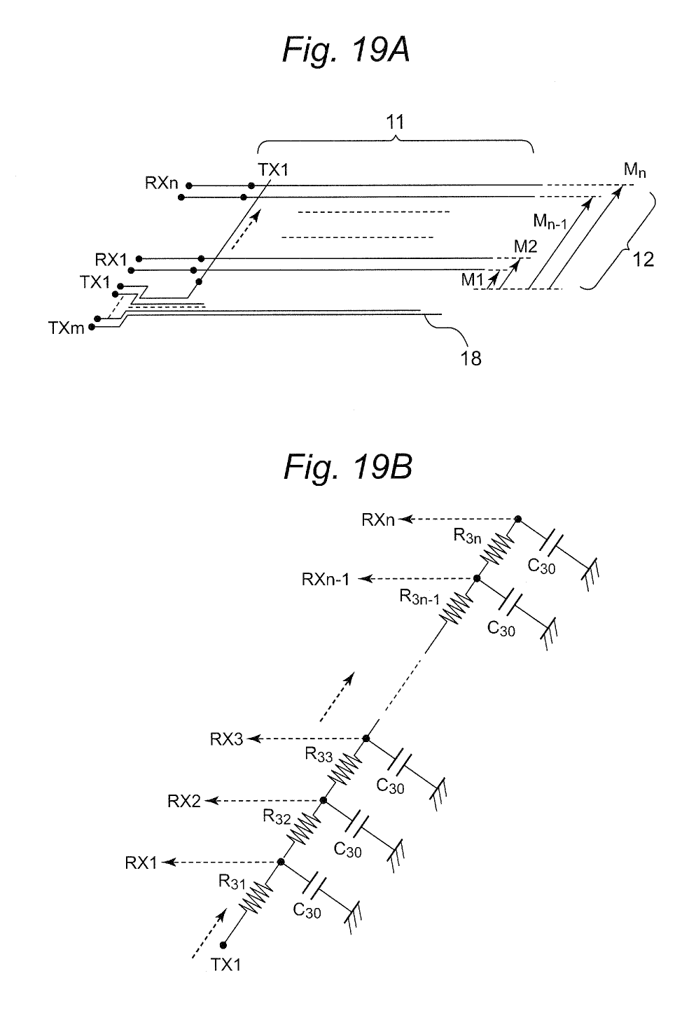

FIG. 19 is a diagram for explaining a time constant of a detection signal at the output end of the detection electrode 12 due to the influence of the time constant of the driving electrode 11 in the first embodiment.

FIG. 19A shows one driving electrode TX1 and a plurality of detection electrodes 12 for convenience of description. A technical concept on the driving electrode TX1 described later can be similarly applied to the other driving electrodes TX2 to TXm. FIG. 19B shows an equivalent circuit of the driving electrode TX1. The equivalent circuit is expressed by a multi-stage circuit of CR as in FIG. 19B. The other driving electrodes TX2 to TXm can also be expressed by the same equivalent circuit. Here, when the resistance ratio of the unit length of the driving electrode 11 is ρ3, a resistance value R3i (i=1, 2 . . . m) of each of the driving electrodes TX1 to TXm can be expressed by Expression (7).

R3i=ρ3·(Mi−M(i−1)) (7)

Here, when R31=ρ3·M1=R30 and M1=Mi−M(i−1), R3i=R30.

Further, when an equivalent capacitance at the intersection between the driving electrode TX1 and each of the detection electrodes RX1 to RXn is C30, the equivalent circuit is expressed by FIG. 19B. The time constant τ3k (k=1, 2 . . . n) at the output end of each of the detection electrodes RX1 to RXn is expressed by Expression (8) by use of Elmore approximation.

τ3k=k·(k+1)·C30·R30/2 (8)

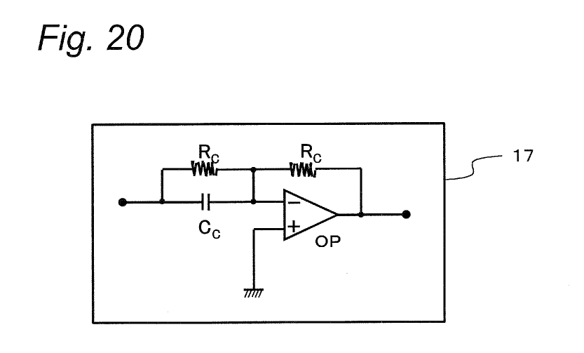

Hereinafter, the configuration and the operation of the phase compensator 17 is described. FIG. 20 is a diagram showing a constitutional example of the phase compensator 17 in the first embodiment. The phase compensator 17 is composed of an operational amplifier OP, a capacitor Cc and a resistor Rc. Expression (9) shows a transmission function G(jω) of the phase compensator 17.

G(jω)=1+jωCcRc (9),

where, j is an imaginary unit, and ω is an angular frequency.

The phase compensator 17 is a differential circuit, and corrects the detection signal (the output signal of the integrator 16) such that a change in rising/falling in the detection signal becomes steep (see FIG. 10). This accelerates the rising/falling of the detection signal, to correct the time constant.

Therefore, in the phase compensator 17 connected to each of the detection electrodes RX1 to RXn, a time constant Cck·Rck (k=1, 2 . . . n) is set such that the following expression is established with each of time constants τ31 to τ3n at the output end of each of the detection electrodes RX1 to RXn with respect to the driving electrode TX1.

Cck·Rck=τ3k=k·(k+1)·C30·R30/2(k=1,2 . . . n) (10)

In this manner, it is possible to correct the difference in time constant between the driving electrodes 11.

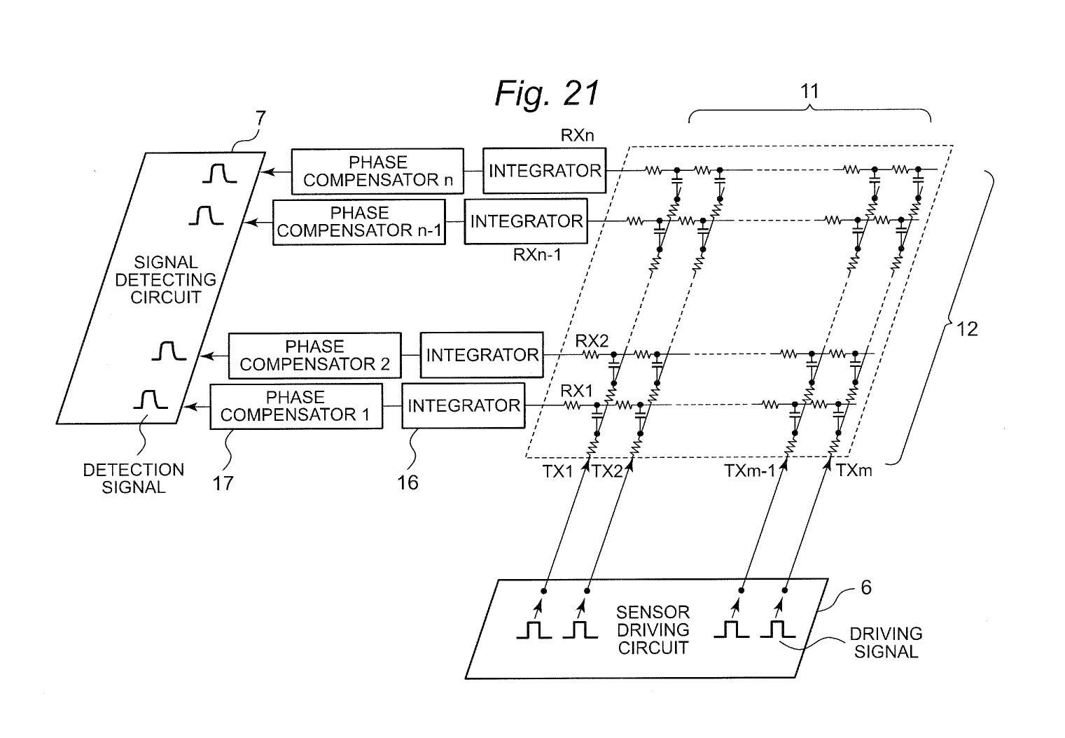

FIG. 21 is a diagram showing an example of the operation of the phase compensator. According to the present embodiment, a difference in time constant among detection signals is corrected by the phase compensator 17. By accelerating the rising/falling of the detection signal shown in FIG. 10 with the phase compensator 17, it is possible to make uniform the time constant of the detection signal outputted from each of the phase compensations 1 to n as shown in FIG. 21.

As stated above, the input device for detecting the touch operation on the liquid crystal display device of the present embodiment includes a plurality of integrators 16, each of which integrates output of the detection electrode 12, a plurality of signal correctors 15, each of which adds the correction signal to the driving signal and applies the obtained signal to the driving electrode, and a plurality of phase compensators 17, each of which performs phase compensation for accelerating response of rising/falling of output of the integrator 16.

With this configuration, it is possible to uniform the time constant of the detection signal which is varied according to the length of each detection electrode, so as to prevent deterioration in detection accuracy of the touch operation.

### 1-3. Effects, Etc.

As described above, the input device disposed on/in the liquid crystal display device of the present embodiment is an input device for detecting a touch operation performed by the user. The input device includes a plurality of driving electrodes 11, and a plurality of detection electrodes 12 disposed intersecting with the driving electrodes. The input device detects a position touched by the user by applying a driving signal to the driving electrode 11 and detecting a detection signal outputted from each of the detection electrodes 12. The detection signal varies with a change in capacitance at an intersection between the driving electrode 11 and the detection electrode 12. The input device further includes a plurality of signal correctors 15, each of which is provided for each driving electrode. The signal corrector 15 adds a correction signal to the driving signal in a rising portion and/or a falling portion of the driving signal, and applies the driving signal added with the correction signal to the driving electrode 11.

By the signal corrector 15 adding the correction signal to the driving signal, it is possible to prevent deterioration in response of rising/falling of a signal due to the time constant because of the length of the detection electrode 12 or the leading line of the driving electrode 11. It is further possible to make varied time constants uniform among the plurality of detection electrodes 12 and among the plurality of driving electrodes 11. It is thereby possible to reduce the influence of the time constant of the driving electrode 11 or the detection electrode 12, so as to reduce deterioration in detection accuracy during a touch operation.

In addition to, or in place of the signal correctors 15, the input device in the present disclosure may include a plurality of integrators 16, each of which integrates output of each of the plurality of detection electrodes 12, and a plurality of phase compensators 17, each of which performs phase compensation for accelerating response of rising/falling of output of each integrator.

With the phase compensator 17, it is possible to prevent deterioration in response characteristics of rising/falling of output (i.e., detection signal) of the integrator 16. Further, output (i.e., detection signal) of the integrator 16 can be corrected such that the response characteristics of rising/falling of output (i.e., detection signal) of the integrators 16 are uniform among the driving electrodes 11. It is thereby possible to reduce the influence of the time constant of the driving electrode 11 or the detection electrode 12, so as to reduce deterioration in detection accuracy during a touch operation.

### Other Embodiments

As described above, the first embodiment has been described as an example of the technique in the present disclosure. However, the present disclosure is not restricted to this, and is applicable to an embodiment where a change, replacement, addition, omission or the like has been performed as appropriate. Further, a new embodiment can be formed by combining each of the constituent elements described in the above first embodiment.

Although both the signal corrector 15 and the phase compensator 17 are provided in the input device of the first embodiment, either one of the signal corrector 15 and the phase compensator 17 may be provided. That is, in the first embodiment, there has been described the configuration which reduces all influences of (1) the time constant of the leading line of the driving electrode 11, (2) the time constant of the detection electrode 12, and (3) the time constant of the driving electrode 11. However, the signal corrector 15 and/or the phase compensator 17 may be provided so as to reduce the influence of at least one of (1) to (3).

Moreover, although Elmore approximation is used in calculation of the time constant in the first embodiment, this is not restrictive.

The constitutional elements described in the attached drawings and the detailed description not only include constitutional elements essential for solving the problem, but also include constitutional elements not essential for solving the problem in order to illustrate the above technique. Accordingly, those nonessential constitutional elements should not be immediately certified as essential by being described in the drawing or the detailed description.

Further, since the foregoing present embodiment is one for illustrating the technique in the present disclosure, a variety of changes, replacement, addition, omission and the like can be performed in the claims and in a range equivalent thereto.

### INDUSTRIAL APPLICABILITY

The present disclosure is applicable to an input device for detecting a touch operation and a display device provided with the input device.

What is claimed is:

1. An input device for detecting a touch operation performed by a user comprising:
a plurality of driving electrodes; and
a plurality of detection electrodes which are disposed intersecting with the driving electrodes;
wherein a position touched by a user is detected by applying a driving signal to the driving electrode and detecting a detection signals outputted from each of the detection electrodes, the detection signal varying with a change in capacitance at an intersection between the driving electrode and the detection electrode, and
the input device further comprises a plurality of signal correctors, each of which is provided for each driving electrode, the signal corrector configured to add a correction signal to the driving signal in a rising portion and/or a falling portion of the driving signal and apply the driving signal added with the correction signal to the driving electrode.

2. The input device according to claim 1, wherein amount of correcting in each signal corrector is set according to a length of a leading line of the driving electrode connected to the signal corrector.

3. The input device according to claim 1, wherein amount of correcting in each signal corrector is set according to a length between a position at which the detection electrode intersects with the driving electrode connected to the signal corrector, and an output end of the detection electrode.

4. The input device according to claim 1, further comprising a plurality of integrators each of which is configured to integrate each of outputs from the detecting electrodes, and a plurality of phase compensators each of which is configured to perform phase compensation to accelerate response of rising and/or falling of each of outputs of the integrators.

5. The input device according to claim 4, wherein characteristics of phase compensation of the phase compensator is set according to a length between a point at which the detecting electrode connected to the phase compensator via the integrator intersects with the driving electrode, and an input end of the driving electrode.

6. An input device for detecting a touch operation performed by a user comprising:
a plurality of driving electrodes; and
a plurality of detection electrodes which are disposed intersecting with the driving electrodes;
wherein a position touched by a user is detected by applying a driving signal to the driving electrode and detecting a detection signals outputted from each of the detection electrodes, the detection signal varying with a change in capacitance at an intersection between the driving electrode and the detection electrode, and
the input device further comprising:
a plurality of integrators each of which is configured to integrate each of outputs from the detecting electrodes; and
a plurality of phase compensators each of which is configured to perform phase compensation to accelerate response of rising and/or falling of each of outputs of the integrators.

7. The input device according to claim 6, wherein characteristics of phase compensation of the phase compensator is set according to a length between a point at which the detecting electrode connected to the phase compensator via the integrator intersects with the driving electrode, and an input end of the driving electrode.

8. A display device comprising:
a display unit that updates a displayed image by applying scanning signals to a plurality of scanning signal lines in one frame period; and
an input device according to claim 1, that detects a position touched by the user in a period synchronous with a period for updating the displayed image.

9. A display device comprising:
a display unit that updates a displayed image by applying scanning signals to a plurality of scanning signal lines in one frame period; and
an input device according to claim 6, that detects a position touched by the user in a period synchronous with a period for updating the displayed image.
